(19) United States
(12) Patent Application Publication
(10) Pub. No.: US 2002/0182916 A1
(43) Pub. Date: Dec. 5, 2002

(54) IC socket

(75) Inventors: Katunori Takahashi, Tokyo (JP); Makoto Sasaki, Tokyo (JP)

Correspondence Address: Finnegan, Henderson, Farabow,, Garrett & Dunner, L.L.P., 1300 I Street, N.W., Washington, DC, 20005-3315, US

(73) Assignee: Yamaichi Electronics Co., Ltd.

(21) Appl. No.: 10/158,066

(22) Filed: May 31, 2002

(30) Foreign Application Priority Data
Jun. 1, 2001 (JP) 2001-167146

(51) Int. Cl. H01R 11/22

(52) U.S. Cl. 439/266

(57) ABSTRACT

An IC socket capable of performing an automatic loading of an IC package with ease is provided. The open top type IC socket includes a socket body and a cover member vertically movably mounted on the socket body to open and close contacts, wherein the socket body has a mounting portion for supporting a loaded IC package and positioning portions formed at positions matching with free ends of lead terminals extending from the loaded IC package and wherein the cover member has a square opening facing the mounting portion.

This application is based on Patent Application No. 2001-167146 filed Jun. 1, 2001 in Japan, the content of which is incorporated hereinto by reference.

### BACKGROUND OF THE INVENTION

1. Field of the Invention

The present invention relates to an IC socket for inspecting IC packages in a semiconductor manufacturing process, and more particularly to an open top type IC socket comprising a socket body and a cover member vertically movably mounted on the socket body to open and close contacts.

2. Description of the Related Art

In this kind of IC socket, conventional measures to ensure efficient mounting and positioning of a mass-produced IC package on the IC socket by using a robot include providing projections to the socket body to restrict the movement of the IC package for its positioning, or erecting guide posts at corners of the socket body for positioning the IC package at a predetermined location.

In the conventional IC socket of a type that has positioning projections in the socket body for restricting the movement of the IC package, there is problem that, because of lateral deviations of the IC package loaded by the robot or inclinations of the package while falling, lead terminals of the IC package are obstructed by the projections, preventing the IC package from being placed at a predetermined position.

Further, in the conventional IC socket with guide posts, when an IC package is picked up by suction using a robot for mounting on the IC socket, the guide posts become obstructions restricting a path of the moving robot.

### SUMMARY OF THE INVENTION

It is therefore an object of the present invention to solve the problems described above and provide an IC socket that allows an automatic mounting of IC packages and which does not restrict the path of the moving robot.

According to one aspect of the present invention, an IC socket is provided which solves the problems described above and is an open top type IC socket which comprises: a socket body; and a cover member vertically movably mounted on the socket body to open and close contacts; wherein the socket body has a mounting portion for supporting a loaded IC package and positioning portions formed at positions matching with tip ends of lead terminals extending from the loaded IC package; wherein the cover member has a square opening facing the mounting portion.

The cover member may have an inclined guide wall surface communicating with the opening and adapted to guide the loaded IC package; the socket body may have guide portions situated between the cover member and the mounting portion and having inclined surfaces, the inclined surfaces having an inclination almost equal to that of the inclined guide wall surfaces, the inclined surfaces becoming aligned with the inclined guide wall surfaces when the cover member is moved down; and at least opposing inner edges of the guide portions may be situated at positions almost overlapping the positioning portions.

The mounting portion in the case of a 2-point-contact type socket may include contacts fixedly arranged in the socket body, and the positioning portions may be formed integral with the contacts. According to another aspect of the present invention, there is provided an IC socket comprising:

a socket body including a socket base and a positioning mount disengageably provided on the socket base, the positioning mount having a mounting portion with a flat upper surface for supporting a loaded IC package;

a plurality of contacts arrayed along at least two opposing sides of the socket body, each of the contacts having a base portion embedded in the socket base, an arm extending from the base portion and having a contact tip at a free end thereof, and an operation lever connected to the arm, all these parts of the contact being formed integral as one piece; and

a cover member vertically movably mounted on the socket body, the cover member having a substantially square opening facing the mounting portion, an inclined guide wall surface communicating with the opening and an inclined cam surface engaging with the operation lever;

wherein the positioning mount has positioning portions protruding from the flat upper surface of the mounting portion at positions matching with tip ends of lead terminals extending from a loaded IC package.

According to still another aspect of the present invention, there is provided an IC socket comprising:

a socket body including a socket base, a pedestal mounted on the socket base and a positioning mount supported on the pedestal, the positioning mount having a mounting portion with a flat upper surface;

a plurality of contacts arrayed along at least two opposing sides of the socket body, each of the contacts having a base portion embedded in the socket base, a first arm extending from the base portion and having a first contact tip at a free end thereof, a second arm extending from the base portion and having a second contact tip at a free end thereof, and an operation lever connected to the second arm, all these parts of the contact being formed integral as one piece; and

a cover member vertically movably mounted on the socket body, the cover member having a substantially square opening facing the mounting portion, an inclined guide wall surface communicating with the opening and an inclined cam surface engaging the operation lever;

wherein the first contact tips are fixedly arranged on an upper periphery of the pedestal and close to a side surface of the positioning mount so that upper surfaces of the first contact tips are flush with an upper surface of the positioning mount, and positioning projections are formed at outer ends of the first contact tips.

Here, the plurality of contacts may be arrayed along four sides of the socket body.

Here, the positioning mount may have guide portions situated between the cover member and the mounting portion and having inclined surfaces, the inclined surfaces having an inclination almost equal to that of the inclined guide wall surfaces, the inclined surfaces becoming aligned with the inclined guide wall surfaces when the cover member is moved down; and at least opposing inner edges of the guide portions may be situated at positions almost overlapping the positioning portions.

Further, the positioning projections may be formed at positions matching with tip ends of lead terminals extending from the loaded IC package.

Finally, the positioning mount may have guide portions situated between the cover member and the mounting portion and having inclined surfaces, the inclined surfaces having an inclination almost equal to that of the inclined guide wall surfaces, the inclined surfaces becoming aligned with the inclined guide wall surfaces when the cover member is moved down; and at least opposing inner edges of the guide portions may be situated at positions almost overlapping the positioning projections.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a plan view showing an IC socket as one embodiment of the present invention;

FIG. 2 is a cross-sectional view taken along the line II-II of FIG. 1, showing an IC package being inserted;

FIG. 3 is a cross-sectional view taken along the line II-II of FIG. 1, showing the IC package in a completely inserted state; and

FIG. 4 is a cross-sectional view of an IC socket as another embodiment of the present invention.

### DETAILED DESCRIPTION OF PREFERRED EMBODIMENTS

Embodiments of the present invention will be described by referring to the accompanying drawings.

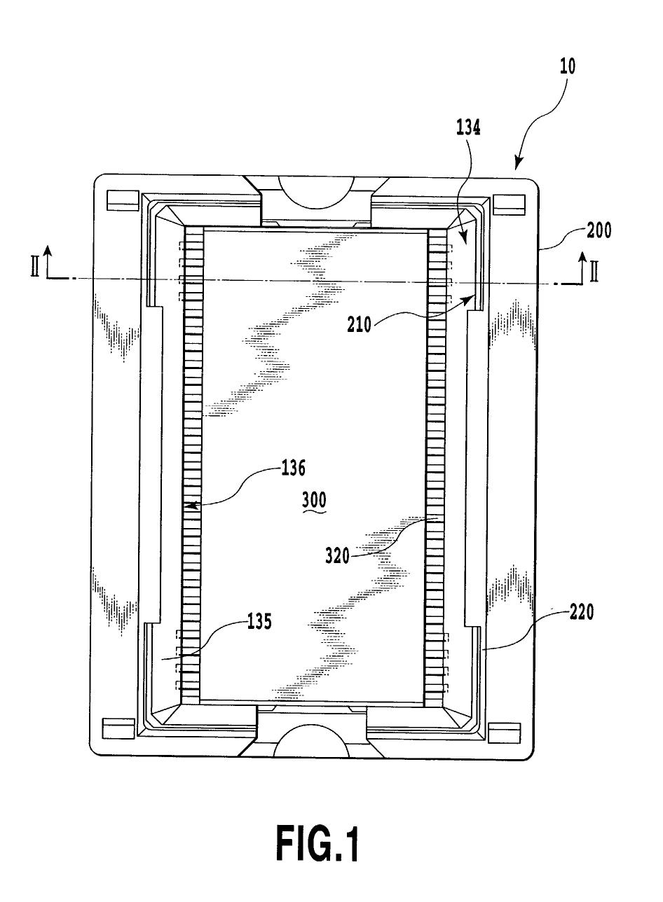

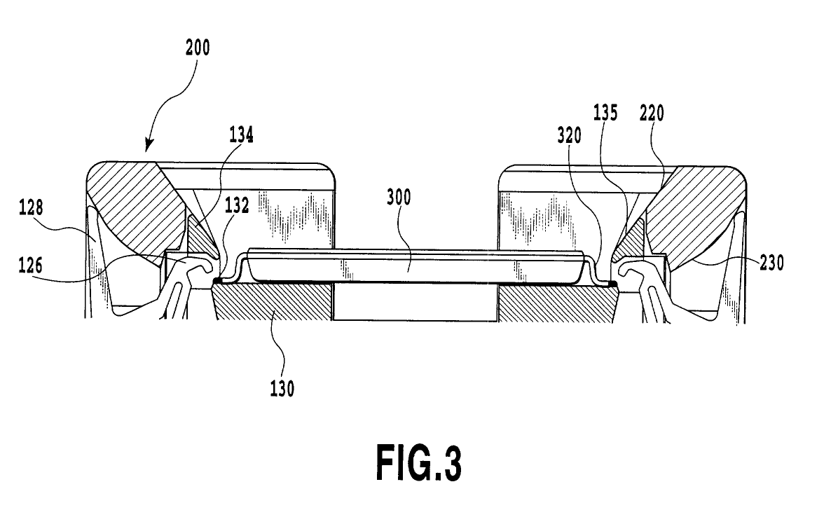

As shown in FIG. 1 to FIG. 3, an IC socket 10 according to one embodiment of this invention is an open top type IC socket which generally has a socket body 100 and a cover member 200 vertically movably mounted on the socket body 100 to open and close contacts described later.

The socket body 100 includes a socket base 110 formed from a substantially square insulating substrate which has a plurality of contacts 120 arrayed at two opposing sides thereof, respectively. At a central part of the socket base 110, a substantially square positioning mount 130 is disengageably provided on the socket base 110.

The positioning mount 130 forms a mounting portion 131 which has a flat upper surface and supports an IC package 300 mounted on the IC socket 10. A plurality of positioning projections 132 protruding from opposite end portions of each of two opposing sides of the mounting portion 131 position tip ends of a plurality of lead terminals 320 extending from opposing sides of a resin body 310 of the IC package 300 and support them on the mounting portion 131. In more detail, the positioning projections 132 are arranged at opposite end portions of each of the two opposing sides of the mounting portion 131 at a pitch equal to that of the lead terminals 320 of the IC package 300 so as to position the IC package 300 either with being in contact with the tip end portions of the lead terminals 320 or through small gaps.

Each of the contacts 120 is a so-called one-point contact type having one contact and has a base portion 122 embedded in the socket base 110, an arm 126 extending from the base portion 122, and an operation lever 128 connected to the arm 126, all integrally formed by punching and made of a conductive material. The arm 126 is integrally formed at its free end with a contact tip 127. The arm 126 also has a curved elastic portion 129 at an intermediate portion thereof.

Further, the positioning mount 130 has a large number of slits formed at an outer peripheral portion thereof at the same pitch and in the same number as those of the contacts 120 and of the lead terminals 320 of the IC package 300. Each of the slits accommodates the arm 126 of the contact 120 and guides the arm 126 as it is moved.

Next, the cover member 200 has an almost square opening 210 facing the mounting portion 131 and inclined guide wall surfaces 220 that communicates with the opening 210 and guides the loaded IC package 300 onto the mounting portion 131. The square opening 210 is sufficiently larger than an overall dimension of the loaded IC package 300 including its lead terminals 320. The cover member 200 is formed with inclined cam surfaces 230 each of which engages the operation lever 128.

The cover member 200 is mounted vertically movable on the socket body 100 as described above. The positioning mount 130 of the socket body 100 has a guide portion 134 between the cover member 200 and the mounting portion 131. The guide portions 134 have inclined surfaces 135 that have an inclination almost equal to that of the inclined guide wall surfaces 220 and which become aligned with the inclined guide wall surfaces 220 when the cover member 200 is lowered. Inner edges of at least two opposing sides of the guide portion 134 are situated to almost overlap the inner positioning portions of the positioning projections 132. As a result, two opposing sides of an opening 136 formed by the inner edges of the guide portion 134 almost agree with envelopes joining the tip ends of the lead terminals 320 extending from the opposing two sides of the mounted IC package 300.

In the case of an IC package with lead terminals extending from its four sides, a plurality of contacts 120 are arrayed along each of the four sides of the square socket base 110. The four sides of the opening 136 may be set to almost agree with envelopes joining the tip ends of the lead terminals 320.

Further, a plurality of contact tips 127 of the contacts 120 are arranged around the positioning mount 130, which forms the mounting portion 131, and extend through the slits formed below the guide portion 134 onto the mounting portion 131.

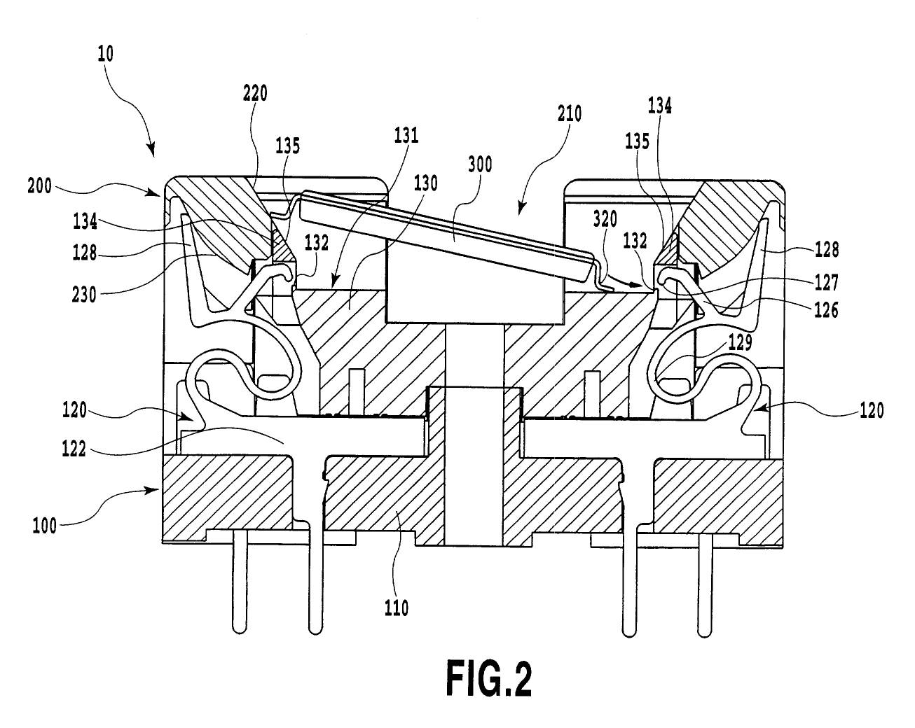

In the IC socket 10 of the above embodiment of this invention, when the cover member 200 is pushed down from above as by a robot arm not shown, the cover member 200 moves down causing the operation lever 128 engaging the inclined cam surface 230 to move against the elastic force of the curved elastic portion 129 of the arm 126, disengaging the contact tip 127 of the arm 126 from the upper surface of the mounting portion 131. In this state, when the IC package 300 that was held by suction as by a robot arm is released, the IC package 300 falls onto the IC socket 10, as shown in FIG. 2.

When the IC package 300 is deviated from a center of the IC socket 10 or inclined while falling, the tip or free ends of the lead terminals 320 of the IC package 300 first engage, and are guided by, the inclined guide wall surface 220 on a deviated side. Then, the free ends of the lead terminals 320 on the opposite side engage the inclined surface 135 of the guide portion 134 on the opposite side or directly the upper surface of the mounting portion 131 and are guided by these surfaces. As a result, with the free ends of the lead terminals 320 on one side sliding down the inclined guide wall surface 220 and/or inclined surface 135 and those on the other side sliding on the positioning mount 130, the IC package 300 inserted at an angle is guided until the free ends of the lead terminals 320 engage the positioning projections 132. The IC package 300 is thus positioned and supported on the upper surface of the mounting portion 131.

When the cover member 200 is lowered, the inclined guide wall surface 220 becomes flush with the inclined surface 135 of the guide portion 134 and the inner edges of at least two opposing sides of the guide portion 134 are situated at positions almost overlapping the positioning portions of the positioning projections 132. Thus, the lead terminals 320 of the IC package 300 that were guided along the inclined surface 135 of the guide portion 134 come into engagement with the positioning projections 132 after they have parted from the inner edges of the inclined surface 135. These lead terminals 320 are therefore positioned correctly.

After this, the robot arm is retracted upward to clear the cover member 200 of the downward pressure, allowing the cover member 200 to be moved up by the elastic force of the curved elastic portions 129. At the same time, the contact tips 127 of the arms 126 bear, from above, on the lead terminals 320 of the IC package 300 placed on the mounting portion 131, thus producing a predetermined contact pressure between the lead terminals 320 and the contact tips 127.

While the contact has been described to be of a so-called 1-point-contact type, which has a single arm, the present invention is also applicable to a so-called 2-point-contact type which has two arms.

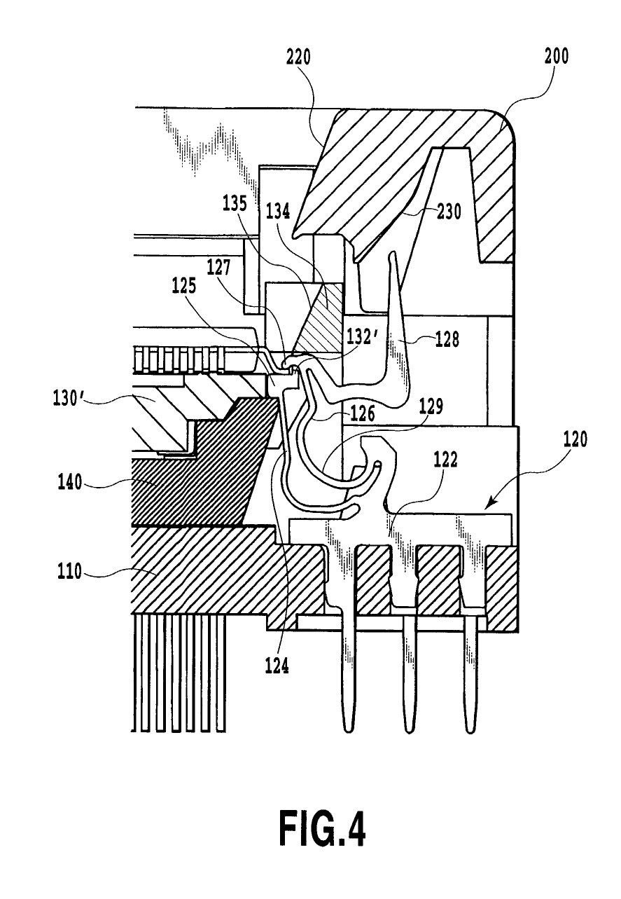

FIG. 4 shows another embodiment in which the present invention is applied to the 2-point-contact type. Functional parts identical with those of the 1-point-contact type are given like reference numerals and their explanations are not repeated here.

In the two-point-contact type of this embodiment, the contacts 120 each have a base portion 122 embedded in the socket base 110, a first arm 124 and a second arm 126 both extending from the base portion 122, and an operation lever 128 connected with the second arm 126, all these formed integral as one piece by punching and made of a conductive material. The first arm 124 has a first contact tip 125 integrally formed at its tip end and the second arm 126 has a second contact tip 127 integrally formed at its tip end. The second arm 126 also has a curved elastic portion 129 at its intermediate portion.

In this embodiment, a positioning mount 130′ is supported on a pedestal 140 mounted on the socket base 110. The first contact tips 125 are fixedly arranged on an upper periphery of the pedestal 140 supporting the positioning mount 130′ and close to the side surface of the positioning mount 130′. The positioning mount 130′, together with the first contact tips 125 whose upper surfaces are flat and flush with the positioning mount 130′, forms a mounting portion 131. Positioning projections 132′ are formed at outer ends of the first contact tips 125.

In this embodiment, since the positioning projections 132′ are formed integral with the first contact tips 125 as by punching, they can be formed more easily than in the previous embodiment in which the positioning projections 132 are formed integral with the positioning mount 130 as by injection molding. Further, because the positioning projections 132′ can also contact the tip end faces of the lead terminals 320 in addition to the fact that the top and bottom surfaces of the lead terminals 320 are brought into contact with the first contact tips 125 and second contact tips 127, this embodiment has an advantage of being able to provide an increased contact area between the lead terminals 320 and the contacts 120.

As can be seen from the foregoing description, because in this embodiment the socket body has a mounting portion for supporting a loaded IC package and positioning portions at locations matching the free ends of the lead terminals extending from the loaded IC package and because the cover member has a square opening facing the mounting portion, the IC package even when deviated or inclined as it falls can be prevented from stalling in the middle of the positioning process and can automatically and easily be set in the IC socket for inspection.

The present invention has been described in detail with respect to preferred embodiments, and it will now be apparent from the foregoing to those skilled in the art that changes and modifications may be made without departing from the invention in its broader aspect, and it is the intention, therefore, in the appended claims to cover all such changes and modifications as fall within the true spirit of the invention.

What is claimed is:

1. An open top type IC socket comprising:
a socket body; and
a cover member vertically movably mounted on the socket body to open and close contacts;
wherein said socket body has a mounting portion for supporting a loaded IC package and positioning portions formed at positions matching with tip ends of lead terminals extending from the loaded IC package;
wherein the cover member has a square opening facing said mounting portion.

2. An IC socket according to claim 1, wherein said cover member has an inclined guide wall surface communicating with said opening and adapted to guide the loaded IC package; said socket body has guide portions situated between the cover member and the mounting portion and having inclined surfaces, the inclined surfaces having an inclination almost equal to that of said inclined guide wall surfaces, the inclined surfaces becoming aligned with the inclined guide wall surfaces when said cover member is moved down; and at least opposing inner edges of the guide portions are situated at positions almost overlapping said positioning portions.

3. An IC socket according to claim 1, wherein said mounting portion in the case of a 2-point-contact type socket includes contacts fixedly arranged in said socket body, and said positioning portions are formed integral with the contacts.

4. An IC socket according to claim 2, wherein said mounting portion in the case of a 2-point-contact type socket includes contacts fixedly arranged in said socket body, and said positioning portions are formed integral with the contacts.

5. An IC socket comprising:
a socket body including a socket base and a positioning mount disengageably provided on the socket base, the positioning mount having a mounting portion with a flat upper surface for supporting a loaded IC package;
a plurality of contacts arrayed along at least two opposing sides of the socket body, each of the contacts having a base portion embedded in said socket base, an arm extending from the base portion and having a contact tip at a free end thereof, and an operation lever connected to the arm, all these parts of the contact being formed integral as one piece; and
a cover member vertically movably mounted on said socket body, the cover member having a substantially square opening facing the mounting portion, an inclined guide wall surface communicating with the opening and an inclined cam surface engaging with the operation lever;
wherein said positioning mount has positioning portions protruding from said flat upper surface of the mounting portion at positions matching with tip ends of lead terminals extending from a loaded IC package.

6. An IC socket according to claim 5, wherein said plurality of contacts are arrayed along four sides of the socket body.

7. An IC socket according to claim 5, wherein the positioning mount has guide portions situated between said cover member and said mounting portion and having inclined surfaces, the inclined surfaces having an inclination almost equal to that of the inclined guide wall surfaces, the inclined surfaces becoming aligned with the inclined guide wall surfaces when the cover member is moved down; and at least opposing inner edges of the guide portions are situated at positions almost overlapping the positioning portions.

8. An IC socket comprising:
a socket body including a socket base, a pedestal mounted on the socket base and a positioning mount supported on the pedestal, the positioning mount having a mounting portion with a flat upper surface;
a plurality of contacts arrayed along at least two opposing sides of the socket body, each of the contacts having a base portion embedded in the socket base, a first arm extending from the base portion and having a first contact tip at a free end thereof, a second arm extending from the base portion and having a second contact tip at a free end thereof, and an operation lever connected to the second arm, all these parts of the contact being formed integral as one piece; and
a cover member vertically movably mounted on the socket body, the cover member having a substantially square opening facing the mounting portion, an inclined guide wall surface communicating with the opening and an inclined cam surface engaging the operation lever;
wherein the first contact tips are fixedly arranged on an upper periphery of the pedestal and close to a side surface of the positioning mount so that upper surfaces of the first contact tips are flush with an upper surface of the positioning mount, and positioning projections are formed at outer ends of the first contact tips.

9. An IC socket according to claim 8, wherein the plurality of contacts are arrayed along four sides of the socket body.

10. An IC socket according to claim 8, wherein the positioning projections are formed at positions matching with tip ends of lead terminals extending from the loaded IC package.

11. An IC socket according to claim 8, wherein the positioning mount has guide portions situated between the cover member and the mounting portion and having inclined surfaces, the inclined surfaces having an inclination almost equal to that of the inclined guide wall surfaces, the inclined surfaces becoming aligned with the inclined guide wall surfaces when the cover member is moved down; and at least opposing inner edges of the guide portions are situated at positions almost overlapping the positioning projections.
